(19) United States
(12) Patent Application Publication
(10) Pub. No.: US 2014/0340599 A1
(43) Pub. Date: Nov. 20, 2014

(54) METHOD FOR INTEGRATING A LIQUID CRYSTAL SCREEN INTO A CARRIER AND LIQUID CRYSTAL SCREEN ARRANGEMENT

(71) Applicants: Marc Rawer, Stuttgart (DE); Manfred Süss, Remchingen (DE)

(72) Inventors: Marc Rawer, Stuttgart (DE); Manfred Süss, Remchingen (DE)

(73) Assignee: Johnson Controls Automotive Electronics GmbH

(21) Appl. No.: 14/344,586

(22) PCT Filed: Sep. 13, 2012
(86) PCT No.: PCT/EP2012/067964

§ 371 Date: Mar. 12, 2014

(30) Foreign Application Priority Data
Sep. 13, 2011 (DE) 10 2011 112 929.8

(51) Int. Cl. G06F 3/044; G02F 1/1339; G02F 1/1335

(52) U.S. Cl. CPC G06F 3/044; G02F 1/13362; G02F 1/1339
USPC 349/12; 349/62; 29/428

(57) ABSTRACT

A method for integrating a liquid crystal screen into a carrier is proposed, wherein a first step involves providing a liquid crystal screen wherein a second step involves applying a polarization film to the liquid crystal screen, and wherein a third step involves sealing a margin and/or an edge of the polarization film at least partly using a seal.

### PRIOR ART

During the front-frameless integration (“seamless integration” or “flush integration”) of liquid crystal screens into an instrument panel of a motor vehicle, polarization films are conventionally applied to the screen in order to reduce reflections of sunlight.

However, the drawback of the prior art is that moisture can penetrate into or under the polarization film, which leads to irreversible separation and/or swelling of the polarization film. Furthermore, the edge of the polarization film is accessible to passengers and could be pulled off.

### DISCLOSURE OF THE INVENTION

It is therefore the object of the present invention to improve the integration of liquid crystal screens into an instrument panel, by the danger of separation and/or swelling of the polarization film being reduced or eliminated.

This object is achieved by a method for integrating a liquid crystal screen into a carrier, wherein, in a first step, a liquid crystal screen is provided, wherein, in a second step, a polarization film is applied to the liquid crystal screen, preferably adhesively bonded on, and wherein, in a third step, a margin or edges of the polarization film are at least partly sealed off with a sealing means, preferably a clear lacquer.

Advantageously, in the method according to the invention, the margin or the edges of the polarization film are sealed off by the sealing means, so that, as opposed to the prior art, penetration of moisture is avoided and therefore the danger of separation and/or swelling of the polarization film is eliminated.

Preferably, in a fourth step, the liquid crystal screen is inserted into a carrier, preferably made of a plastic material, and particularly preferably into an instrument panel of a motor vehicle, and connected to the carrier, preferably by adhesive bonding, wherein an interspace, which is formed between the polarization film, on the one hand, and the carrier, on the other hand, is sealed off. In order to seal off the interspace, a sealing means, particularly preferably a lacquer or clear lacquer, is preferably applied to the carrier, the liquid crystal screen and/or the polarization film.

A further subject of the present invention is a liquid crystal screen or a liquid crystal screen arrangement having a liquid crystal arrangement and a background illumination illuminating the liquid crystal arrangement, wherein the liquid crystal arrangement is covered with a polarization film, and wherein the liquid crystal screen and/or the polarization film is/are at least partly covered with a sealing means, preferably with a clear lacquer.

By means of sealing off the interspace, moisture is advantageously prevented from being able to penetrate in or under the polarization film, by which means the durability of the polarization film can be substantially improved. Provision is preferably made for the polarization film to project at least partly over a margin and/or over edges the liquid crystal screen or to overlap the margin and/or the edges of the liquid crystal screen. That part of the polarization film which projects over the margin of the liquid crystal screen is likewise connected to the carrier, preferably adhesively bonded. As a result, flexible adaptation of the polarization film to different carriers is possible. The polarization film is preferably rounded off at its edges, so that a comparatively good aesthetic impression can advantageously be achieved.

The polarization film and the liquid crystal screen are preferably connected by using an additive method, such as a contact adhesive method, adhesive bonding and/or a laminating method for example.

Preferably, before the sealing off, an active area, i.e. an area of the liquid crystal screen that is employed for the use of the liquid crystal screen, is covered first and after that the liquid crystal screen and/or the polarization film are provided with the sealing means circumferentially at the edges. The sealing means is used to seal off the interspace, the polarization film or a polarization film edge from moisture. The sealing means can also be used to configure the corners of the liquid crystal screen or of a glass substrate of the liquid crystal screen to be rounder, in order to reduce the risk of injury to the occupants, for example during an accident, and/or in order to be able to withstand head impact tests. As a result of the sealing off with the sealing means, it is further advantageously possible for the lower-lying component parts of the liquid crystal screen and for the visible surface (A-surface) of the carrier to be covered. As a result of the application of the polarization film to the liquid crystal screen, it is advantageously possible to dispense with a covering lens. In addition, no negative influences the optical performance of the liquid crystal screen arise from the polarization film, nor any edges on which occupants could be injured. Since the size of the polarization film can be chosen as desired, it is advantageously possible to integrate the liquid crystal screen into carriers having narrow and large frames.

As a result of the polarization film overlapping the margin of the liquid crystal screen, and as a result of connecting the overlapping area of the polarization film to the carrier, it is advantageously possible to apply the covering means without the covering means being able to get between polarization film and liquid crystal screen.

The polarization film is preferably configured so as to only let through light having a specific polarization angle. It goes without saying that the polarization angle coincides with an exit polarization angle of the liquid crystal screen, for which reason the light from the liquid crystal screen is let through, while light which does not have the correct polarization angle is absorbed, by which means a visibility advantage is achieved in surroundings having sunlight.

An anti-glare-anti-reflective (AGAR) layer is preferably applied to the polarization film, in order to control the amount of sunlight or ambient light which is reflected to the user. As a non-restrictive example, the AGAR layer is an anti-glare/anti-reflective film or an anti-glare/anti-reflective coating which is applied to the polarization film. As a further example, the AGAR layer can be a separate film, which is laminated onto the polarization film or is integrated as part of the polarization film. It goes without saying that various configurations can be used in order to produce at least one of an anti-glare (AG) or anti-reflective (AR) surface.

A further subject of the present invention is a liquid crystal screen which can be integrated into an instrument panel or a carrier by the method according to the invention, and also an instrument panel having a liquid crystal screen which has been integrated into the instrument panel by the method according to the invention. A further subject of the present invention is a touch-screen, preferably a capacitive touch-screen, having a liquid crystal screen according to the invention.

Exemplary embodiments of the present invention are illustrated in the drawings and explained in more detail in the following description.

### BRIEF DESCRIPTION OF THE DRAWINGS

FIGS. 1a and 1b show a schematic view of a liquid crystal screen according to the prior art,

FIGS. 2a and 2b show a schematic view of a liquid crystal screen according to an embodiment of the present invention, and

FIGS. 3a, 3b and 4 show a schematic view of a carrier having a liquid crystal screen which has been integrated into the carrier by the method according to the invention.

### EMBODIMENTS OF THE INVENTION

In the various figures, the same parts are always provided with the same designations and are therefore a rule also respectively named or mentioned only once.

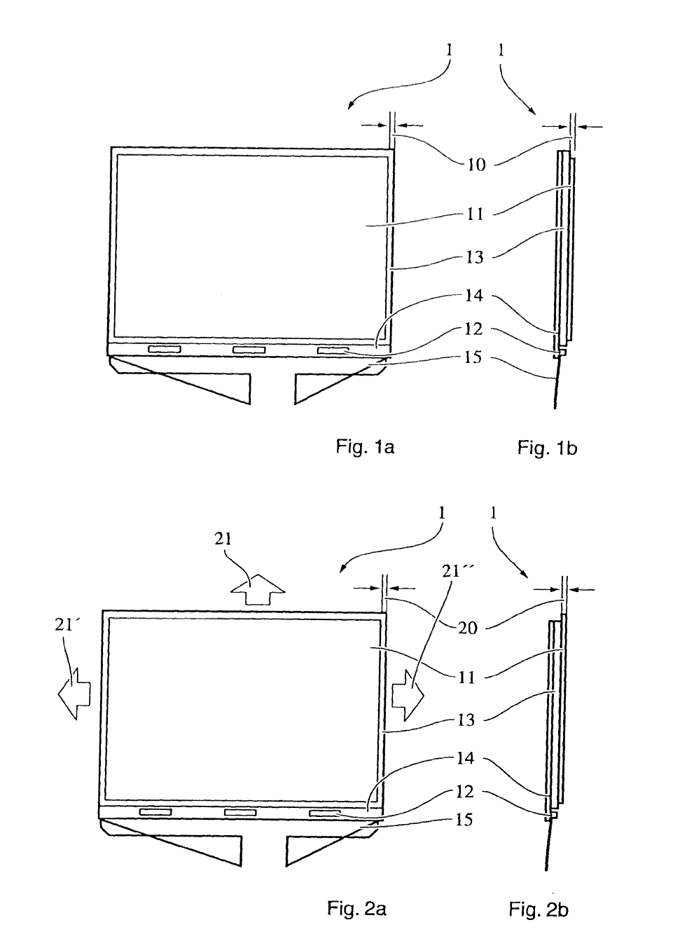

In FIGS. 1a and 1b, a liquid crystal screen 1 according to the prior art is shown. FIG. 1a shows a plan view and FIG. 1b shows a side view of the liquid crystal screen 1. The liquid crystal screen 1 has a liquid crystal arrangement 13. The liquid crystal arrangement 13 has a liquid crystal material which is arranged between two glass substrates. As a non-restrictive example, the liquid crystal arrangement 13 exhibits thin-film transistor (TFT) technology. It goes without saying that the liquid crystal arrangement 13 can be a conventional liquid crystal arrangement which has a plurality of spacers (not illustrated) and seals (not illustrated), as known in the prior art in the field of displays. The glass substrates provide a structure to which additional materials, such as a color filter 14 for example, can be applied. A driver 12 is arranged on the color filter 14. The driver 12 activates the elements of the liquid crystal arrangement 13. At the time at which a component of the liquid crystal arrangement 13 is addressed, a charge, the level of which corresponds to the data information, is applied to the component. After that, the component (e.g. a thin-film transistor, TFT) is switched into a comparatively highly resistive state again, which means that the charge and thus the activation is substantially maintained during an image period.

A polarization film 11 is applied to the liquid crystal arrangement 13. Between the margin of the polarization film 11 and the edges or the margin of the liquid crystal screen 1 or the liquid crystal arrangement 13 there a gap 10, i.e. an area 10 in which no polarization film 11 is applied to the liquid crystal arrangement 13. The gap 10 disadvantageously leads to moisture being able to penetrate into or under the polarization film 11, which leads to irreversible separation and/or swelling of the polarization film 11. Furthermore, the edge of the polarization film 11 is accessible to passengers and could be pulled off.

In FIGS. 2a and 2b, a liquid crystal screen 1 according to an exemplary embodiment of the present invention is shown. FIG. 2a shows a plan view and FIG. 2b shows a side view of the liquid crystal screen 1. The polarization film 11 is applied to the liquid crystal arrangement 13 of the liquid crystal screen 1, the polarization film 11 preferably being adhesively bonded on. According to the invention, the polarization film 11 is arranged in such a way that the polarization film 11 projects over the margin of the liquid crystal screen 1 or over the liquid crystal arrangement 13 or overlaps the margin of the liquid crystal screen 1 or the liquid crystal arrangement 13 along a main plane of extent of the liquid crystal screen 1. The arrows 21, 21′ and 21″ indicate that the polarization film 11 preferably overlaps on only three edges or sides of the liquid crystal screen 1. The fourth edge or side can, for example, be covered by a metalized frame. The width of the overlapping area of the polarization film 11 is indicated by the designation 20.

Integrated circuits or drivers 12 are preferably placed on the underside of the liquid crystal screen 1, preferably being applied by means of COG (chip-on-glass) methods to the color filter 14 of the liquid crystal screen 1. The color filter 14 is connected to the liquid crystal arrangement 13 by using conventional methods. A protective frame or a front frame made of a metalized plastic material is preferably placed on this underside or on this edge as protection against electrostatic discharge. This is possible when the liquid crystal screen 1 is preferably integrated into the instrument panel in the area of the CID (central information display). Even further conventional components, such as flexible printed circuit boards 15 for example, are arranged on the liquid crystal screen

For the purpose of clearer illustration, the sealing means, which, according to the invention, has been applied to the edges of the polarization film 11, has not been shown in FIG. 2a or FIG. 2b.

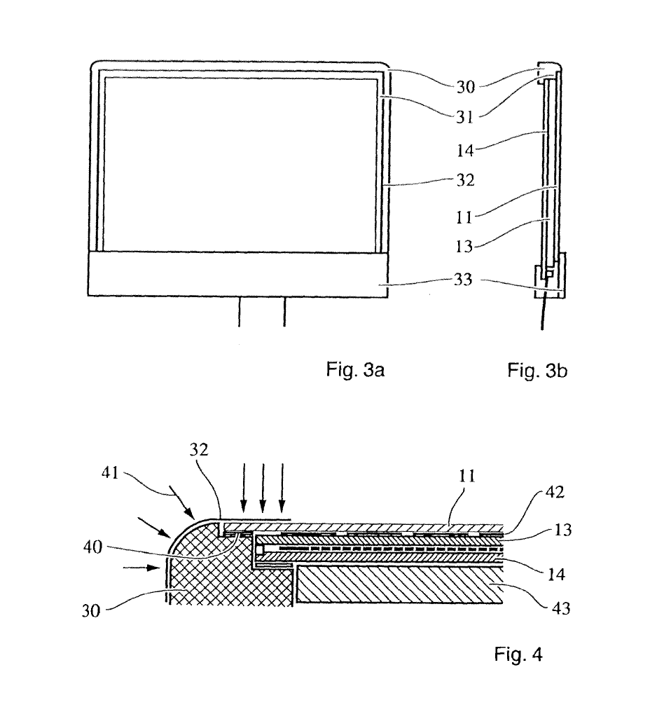

FIG. 3a and FIG. 3b show an instrument panel 30 according to the invention or a carrier 30 according to the invention, into which a liquid crystal screen 1 has been integrated by the method according to the invention. The carrier 30, preferably made of plastic, preferably has rounded-off edges, in order to protect passengers in the event of an accident or in order to withstand crash tests better, these rounded-off edges preferably being produced by the application of a sealing means 30, preferably a lacquer. The designation 31 identifies that point or that area at which or in which the liquid crystal screen 1 is connected to the carrier 30 and the polarization film 11 is connected to the carrier 30, preferably adhesively bonded. The covering with the sealing means 32 is carried out by using conventional methods. The carrier 30 preferably has a protective frame 33 made of a metalized plastic material, which is arranged in the area of the driver 12, by which means improved protection against electrostatic discharge can be advantageously achieved.

FIG. 4 shows a section through the carrier 30 and the liquid crystal screen 1. Arranged behind the color filter 14 and the liquid crystal arrangement 13 is a background illumination 43. The background illumination 43 can be any desired light source which outputs visible radiation to shine through the liquid crystal arrangement 13, since the pixels of the liquid crystal arrangement 13 are substantially optical valves which allow part of the visible radiation from the background illumination 34 to pass through them. The light partially passing through the liquid crystal arrangement 13 is modified by these optical valves in such a way that an image, for example for the display of vehicle, navigation and/or entertainment information or the like, is generated on the liquid crystal screen 1.

Between the liquid crystal arrangement 13 and the polarization film 11, a conductive layer 42 is arranged on the liquid crystal arrangement 13. As a non-restrictive example, the conductive layer 42 is formed from a transparent conductive material, such as indium tin oxide (ITO) for example, or other organic transparent conductors. In specific embodiments, at least one ITO film forms the conductive layer 42. For example, the at least one ITO film can be formed as a single film, a double film and in other specific patterns. In specific embodiments, the conductive layer 42 is applied to the substrate and etched to form a desired pattern. In embodiments in which ITO films are used, the individual films are coupled to the substrate, either directly or indirectly. As a non-restrictive example, the ITO films are laminated to one another or to the substrate by using highly transparent adhesive (optically clear adhesive, OCA) and conductive transition materials.

Between the carrier 30 and the polarization film 11 or the liquid crystal screen 1 there is advantageously no edge, so that frameless integration of the liquid crystal screen 1 into the carrier 30 is possible. FIG. 4 shows how the liquid crystal screen 1 is integrated into the carrier 30, this integration preferably being carried out only on three of four sides or edges. On the fourth side or edge there is preferably a metalized frame, which protects the circuits lying underneath against electrostatic discharge.

The connection in the area 40 between the polarization film 11 and the carrier 30 is preferably produced by an adhesive bonding robot. Also preferably, the sealing means 32 or the lacquer is applied by a coating robot, the lacquer being applied in accordance with the arrows 41.

### LIST OF DESIGNATIONS

1 Liquid crystal screen

10 Gap

11 Polarization film

12 Driver

13 Liquid crystal arrangement

14 Color filter

15 Flexible printed circuit board

20 Width of the overlapping area

21, 21′, 21″ Arrows

30 Instrument panel/carrier

31 Adhesively bonded area

32 Sealing means

33 Protective frame

40 Adhesively bonded area between polarization film and carrier

41 Directional arrow

42 Conductive layer

43 Background illumination

1. A method for integrating a liquid crystal screen into a carrier the method comprising:
in a first step, providing a liquid crystal screen;
in a second step, applying a polarization film to the liquid crystal screen; and
in a third step, at least partly sealing off a margin and/or an edge of the polarization film with a seal.

2. The method as claimed in claim 1, wherein, in the second step, the polarization film is adhesively bonded to the liquid crystal screen.

3. The method as claimed in claim 1, wherein, in the third step, the margin and/or the edges of the polarization film are at least partly sealed off with a lacquer as the seal.

4. The method as claimed in claim 1, wherein, in a fourth step, the liquid crystal screen is inserted into the carrier and connected to the carrier, wherein an interspace, which is formed between the polarization film, on the one hand, and the carrier, on the other hand, is sealed off.

5. The method as claimed in claim 4, wherein, in the fourth step, the liquid crystal screen is inserted into an instrument panel of a motor vehicle as carrier.

6. The method as claimed in claim 4, wherein, in the fourth step, the liquid crystal screen is connected to the carrier by adhesive bonding.

7. The method as claimed in claim 4, wherein, in the fourth step, in order to seal off the interspace, a lacquer is applied to the carrier, the liquid crystal screen and/or the polarization film as the seal.

8. A liquid crystal screen arrangement having a liquid crystal arrangement and a background illumination illuminating the liquid crystal arrangement, wherein the liquid crystal arrangement is covered with a polarization film, and wherein the liquid crystal screen and/or the polarization film is/are at least partly covered with a seal.

9. The liquid crystal screen arrangement as claimed in claim 8, wherein the polarization film projects at least partly over a margin and/or over edges of the liquid crystal screen and/or overlaps the margin and/or the edges of the liquid crystal screen, wherein that part of the polarization film which projects over the margin of the liquid crystal screen connected to the carrier.

10. The liquid crystal screen arrangement as claimed in claim 8, wherein the polarization film is connected to the liquid crystal screen by an additive method.

11. The liquid crystal screen arrangement as claimed in claim 8, wherein the polarization film is configured so as to only let through light having a specific polarization angle.

12. The liquid crystal screen arrangement as claimed in claim 8, wherein an anti-glare-anti-reflective (AGAR) layer is applied to the polarization film.

13. The liquid crystal screen arrangement as claimed in claim 12, wherein the anti-glare-anti-reflective layer is an anti-glare/anti-reflective film or an anti-glare/anti-reflective coating, which is applied to the polarization film, and/or wherein the anti-glare-anti-reflective layer is a separate film, which is laminated onto the polarization film or is integrated as part of the polarization film.

14. The liquid crystal screen arrangement as claimed in claim 8, wherein the liquid crystal screen is integrated into an instrument panel of a motor vehicle.

15. A capacitive touch-screen having a liquid crystal screen arrangement as claimed in claim 8.
